(19) United States
(12) Patent Application Publication
(10) Pub. No.: US 2012/0086798 A1
(43) Pub. Date: Apr. 12, 2012

(54) SYSTEM AND METHOD FOR AUTOMATIC DYNAMIC GUIDELINES

(75) Inventor: Koki Iwazaki, San Marcos, CA (US)

(73) Assignee: Sony Corporation, Tokyo (JP)

(21) Appl. No.: 12/900,356

(22) Filed: Oct. 7, 2010

(51) Int. Cl. H04N 7/18

(52) U.S. Cl. 348/118; 348/E07.085

(57) ABSTRACT

A system and method for automatically generating and outputting video comprising graphical guidelines for assisting in vehicle maneuvering. The system includes an optical sensor and a directional sensor. The system further includes an electronic guideline generator and a video interface. The guideline generator generates guidelines based on at least one dimension of an object coupled to the optical sensor. The video interface is operable to output data comprising information received from the optical sensor and the guideline generator. The directional sensor and the optical sensor are independent of any control from any vehicle navigation system of the vehicle.

### FIELD OF THE INVENTION

Embodiments of the present invention are generally related to aiding maneuvering an object, such as a vehicle.

### BACKGROUND OF THE INVENTION

As technology has advanced, an increasing number of advanced technologies have been integrated into cars, such as navigation systems. While driving forward is relatively natural and easy for most drivers, maneuvering in reverse often presents a variety of challenges. For example, a driver may misjudge the size of the vehicle and the relative distance of the car from certain objects resulting in damage to the vehicle. In addition, an object may be obstructed by portions of the car and thus undiscoverable until it is too late. A conventional but recent solution to this problem is to use a display, usually a display of the navigation system, to display a rearview perspective of the car, e.g., via a rear mounted camera. Such a conventional solution may also display guidelines. An example is disclosed in “Imaging System for Vehicle” by Lu et al., with International Publication No. WO 2009/036176 A1 and published on Mar. 19, 2009.

In conventional solutions, a camera at the back of the car communicates with the navigation system and requires video and control signaling connections. Unfortunately, the control signaling interface requires a signaling interface on both the camera and the navigation system. These signaling interfaces in turn require custom wire harnesses for each navigation system and camera pair. The control signaling interfaces and wiring harnesses add to the overall cost of the rearview system as each requires additional parts and hardware. Further, the navigation system and the camera are required to be custom made as a pair in order to connect and communicate with each other. These customizations require additional parts and development and therefore increase the costs of the rear view system. Additionally, control signaling interfaces between the camera and the navigation system introduce latency thereby negatively impacting performance of the rearview system.

### SUMMARY OF THE INVENTION

Thus, a need exists for an electronic system that aids in maneuvering a vehicle without requiring control signaling interfaces or connections between the system and other parts of the vehicle (e.g., the navigation system or video mirror). Embodiments of the present invention aid in driver maneuvering without requiring custom wiring harnesses and custom control signaling interfaces. This allows embodiments of the present invention to be vehicle system independent (e.g., navigation system and video mirror independent) and thereby reduce vehicle system integration and assembly costs. Embodiments of the present invention further provide dynamic guidelines without the latency associated with conventional systems.

In one embodiment, the present invention is implemented as a system for outputting video comprising maneuvering graphical guidelines. The system includes an optical sensor (e.g., video and/or infrared imaging camera) and a directional sensor (e.g., compass). The system further includes an electronic guideline generator and a video interface. The system may also include a motion sensor (e.g., accelerometer or gyroscope). The guideline generator generates graphical guidelines based on at least one dimension of an object coupled to the optical sensor. The graphical guidelines may be based on the length and width of the object (e.g., vehicle) and the current movement of the vehicle. In one embodiment, the directional sensor and the motion sensor are independent of any control signals of any vehicle navigation or video mirror electronic system. The video interface is operable to output data comprising information received from the optical sensor and the electronic guideline generator. The video interface may comprise a video multiplexer. In another embodiment, the video interface is operable to output the data to a navigation system or a video mirror.

In one embodiment, the present invention is implemented as a system for generating a video signal for display on a display screen. The system includes a camera, a compass, and an accelerometer. The system further includes an electronic guideline generator and a video output interface. The electronic guideline generator is operable to generate images of a plurality of graphical guidelines and is coupled to the compass and the accelerometer. The electronic guideline generator may generate the images of a plurality of guidelines based on a length and width of a vehicle. The system may further include a multiplexer operable to multiplex signals from the electronic guideline generator and the camera. In one embodiment, the compass and the accelerometer are independent of any control from any vehicle navigation system or video mirror. The video output interface is operable to be coupled to a display device of a navigation system or video mirror which displays video comprising video from the camera with signals indicative of the graphical guidelines from the guideline generator. In another embodiment, the camera is a wide angle lens and the system further comprises a processing unit operable to flatten an image captured by the camera.

In another embodiment, the present invention is implemented as a method for automatically generating graphical guidelines for aiding in vehicle maneuvering. The method includes accessing, within an electronic system, directional sensor data and automatically determining a plurality of graphical guidelines based on the directional sensor data (e.g., from a compass). The guidelines may be also based on the length and width of a vehicle. In one embodiment, the guidelines are determined upon determining a change in direction based on the directional sensor data or upon accessing motion sensor data and determining whether movement has occurred. In one embodiment, the directional sensor data is collected by a directional sensor that is independent of any control from any vehicle navigation system or video mirror. The method further includes accessing sensor data (e.g., from an optical sensor) and integrating the plurality of guidelines into data from the sensor. Then image data comprising the plurality of guidelines and the data from the sensor may be provided to a display unit. In one embodiment, the image data is sent to a navigation system or video mirror. The displayed image data may then assist a vehicle operator in maneuvering the vehicle.

In this manner, embodiments of the present invention facilitate display of external perspectives of a vehicle with dynamic displayed guidelines while not requiring control signal connections or custom wire harnesses to the navigation system or video mirror. Embodiments of the present invention are thereby operable to provide vehicle-system-independent (e.g., navigation system and video mirror independent) rearview video perspectives. Embodiments of the present invention further provide for the generation and display of dynamic graphical guidelines without the latency associated with conventional systems.

### BRIEF DESCRIPTION OF THE DRAWINGS

The present invention is illustrated by way of example, and not by way of limitation, in the figures of the accompanying drawings and in which like reference numerals refer to similar elements.

FIG. 1 shows exemplary components of a vehicle in accordance with one embodiment of the present invention.

FIG. 2 shows an exemplary system for outputting images including graphical guidelines in accordance with one embodiment of the present invention.

FIG. 3 shows exemplary components of a system for outputting video including graphical guidelines in accordance with one embodiment of the present invention.

FIGS. 4A-B show exemplary graphical guidelines in accordance with one embodiment of the present invention.

FIG. 5 shows a flowchart of an exemplary process for outputting video in accordance with one embodiment of the present invention.

FIG. 6 shows exemplary components of a system with computing functionality for providing a rear view image in accordance with one embodiment of the present invention.

### DETAILED DESCRIPTION OF THE INVENTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail as not to unnecessarily obscure aspects of the embodiments of the present invention.

### Notation and Nomenclature:

Some portions of the detailed descriptions, which follow, are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

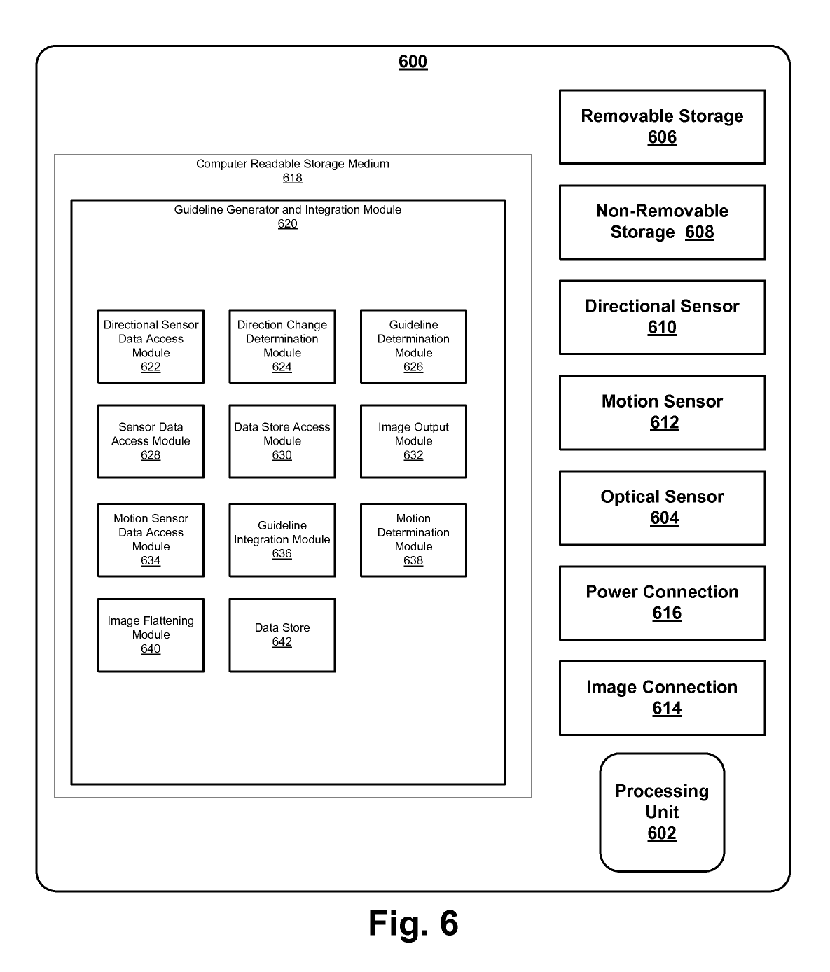

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “ processing” or “accessing” or “ executing” or “ storing” or “rendering” or the like, refer to the action and processes of a system having computing functionality (e.g., system 600 of FIG. 6), or similar electronic computing device, that manipulates and transforms data represented as physical (electronic) quantities within the computer system's registers and memories into other data similarly represented as physical quantities within the computer system memories or registers or other such information storage, transmission or display devices.

### Exemplary Systems and Methods:

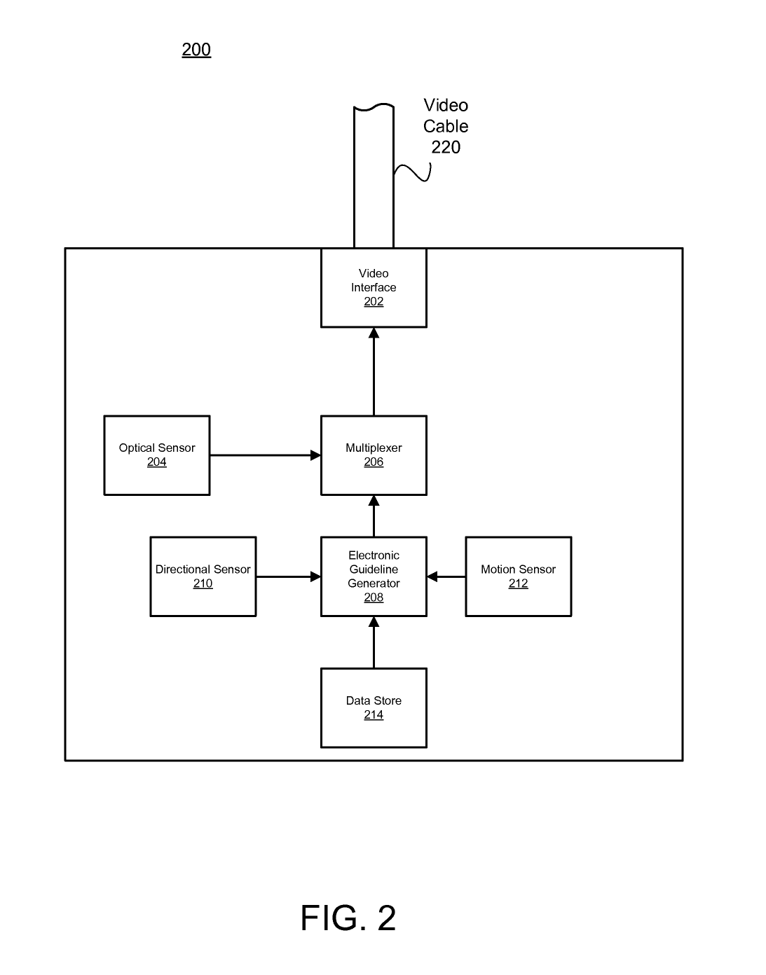

FIGS. 2-3 and 6 illustrate exemplary components used by various embodiments of the present invention. Although specific components are disclosed in systems 200-300 and 600 it should be appreciated that such components are examples. That is, embodiments of the present invention are well suited to having various other components or variations of the components recited in systems 200-300 and 600. It is appreciated that the components in systems 200-300 and 600 may operate with other components than other those presented, and that not all of the components of systems 200-300 and 600 may be required to achieve the goals of systems 200-300 and 600.

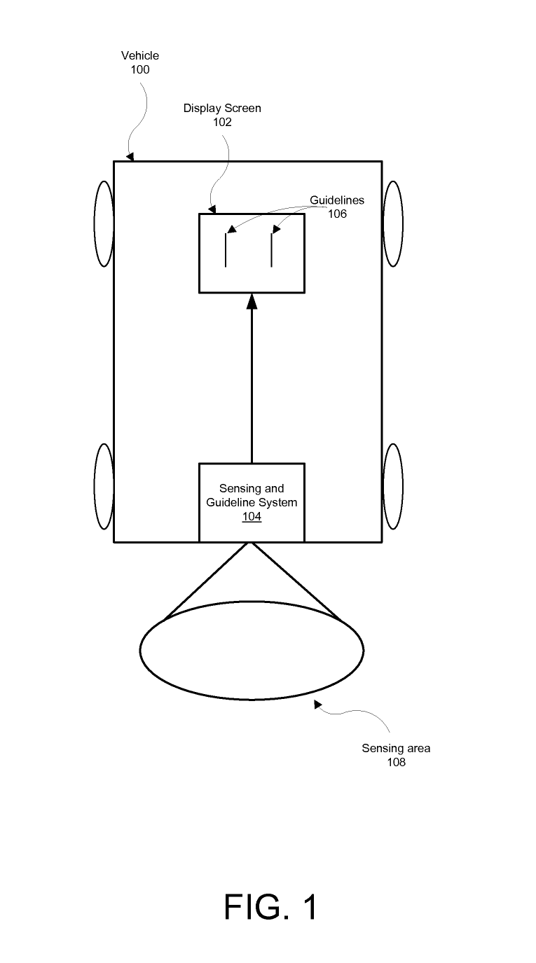

FIG. 1 shows exemplary components of a vehicle in accordance with one embodiment of the present invention. Vehicle 100 includes display screen 102 and sensing and guideline system 104. Vehicle 100 may be a variety of devices designed or used to transport people or cargo including cars, trucks, buses, ships, boats, aircraft, hovercraft, spacecraft, treaded vehicles, etc. Sensing and guideline system 104 gathers information from sensing area 108 and determines graphical guidelines based on information gathered from sensing area 108. The guidelines may be displayed on a screen of the vehicle. Sensing and guideline system 104 further integrates the determined guidelines with information from sensing area 108 for display on display screen 102. The information from sensing area 108 with the integrated guidelines is then sent to display screen 102 which displays guidelines 106. Graphically depicted guidelines 106 may then be used by a driver to aid in maneuvering vehicle 100 in reverse (e.g., to park vehicle 100) for instance. It is appreciated that system 104 and sensing area 108 may be located on any side or area of vehicle 108 (e.g., left side, right side, front side, corners, etc.). It is appreciated that display screen 102 may comprise multiple displays and/or multiple types of displays (e.g., liquid crystal displays, video mirror displays, etc.).

FIG. 2 shows an exemplary system for generating and outputting images including graphical guidelines in accordance with one embodiment of the present invention. System 200 includes video interface 202, optical sensor 204, multiplexer 206, guideline generator 208, directional sensor 210, motion sensor 212, and data store 214. System 200 is coupled to a display screen (e.g., display screen 106) via video cable 220. In one embodiment, system 200 outputs a video stream including guidelines via video interface 202 to a display screen for use in a maneuvering a vehicle. Although a cable 220 is shown the video signal could also be transmitted wirelessly.

Optical sensor 204 is coupled to multiplexer 206 and optical sensor 204 collects information for sending over video cable 220 via video interface 202. In one embodiment, optical sensor 204 is an optical sensor capable of visible light and/or infrared imaging. Sensor 204 may be a video camera or other image capture device. In another embodiment, optical sensor 204 includes a wide angle lens.

Electronic guideline generator 208 is an electronic device that generates graphical guidelines (e.g., guidelines 462-466) based on accessing information from directional sensor 210, motion sensor 212, and data store 214. Directional sensor 210 outputs directional information, which in one embodiment is operable to reflect changes in direction of an object (e.g., vehicle 100). Directional sensor 210 may be a variety of well known directional sensing devices including a compass or a global position device, etc.

Motion sensor 212 senses motion of system 200 and objects coupled to system 200 (e.g., vehicle 100). Motion sensor 212 may be a variety of well known motion sensing devices including an accelerometer, gyroscope, optical and infrared sensors, video image processors, inertia-switch sensors, infrared laser radars, ultrasonic sensors, and microwave radar sensors, etc. In one embodiment, motion sensor 212 collects information which is used to determine whether guideline generator 208 should generate new guidelines based on movement (e.g., of vehicle 100).

Data store 214 stores information operable to be used by guideline generator 208 in generating guidelines. For example, data store 214 may include a memory for storing dimensions of an object including the length, width (e.g., of vehicle 100), and height of system 200 relative to the ground.

Multiplexer 206 is coupled to optical sensor 204, guideline generator 208, and video interface 202. In one embodiment, multiplexer 206 is a video multiplexer and multiplexes video signals from optical sensor 204 with signals depicting guidelines from guideline generator 208 for output over video interface 202. Multiplexer 206 may multiplex on a frame by frame basis. For example, guideline generator 208 may output guidelines as an image or frame to multiplexer.

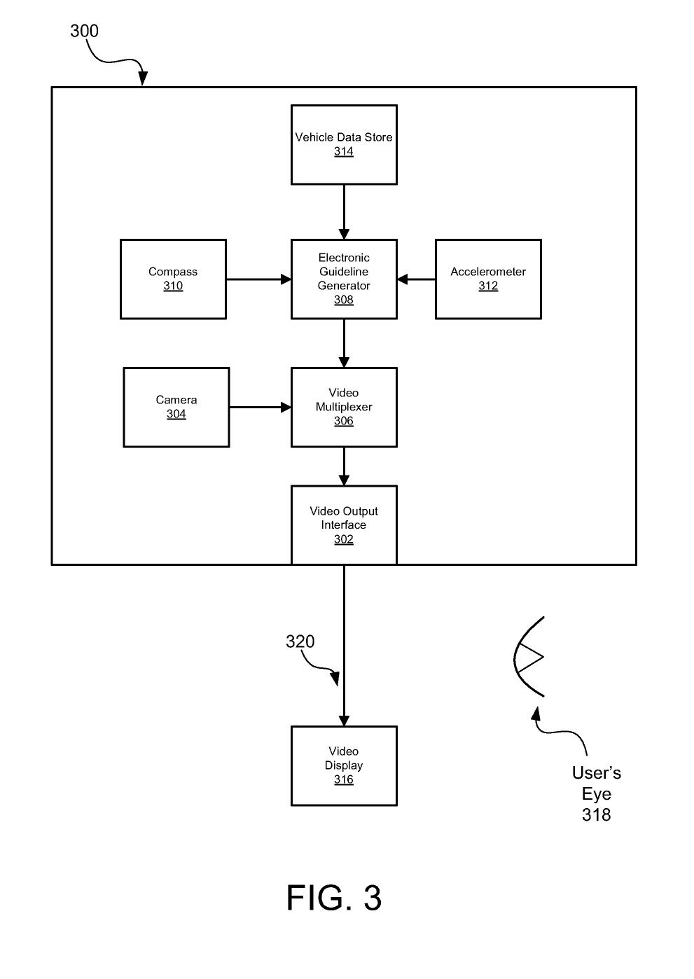

FIG. 3 shows exemplary components of a system for outputting video with graphical guidelines in accordance with one embodiment of the present invention. System 300 includes camera 304, video multiplexer 306, compass 310, guideline generator 308, accelerometer 312, and vehicle data store 314. System 300 sends video stream 320 to video displays 316 for display to user's eye 318. Video stream 320 may be an analog or digital video stream.

Video stream 320 includes video from camera 304 and guidelines from guideline generator 308. In one embodiment, video stream 320 is output from video multiplexer 306 which multiplexes guidelines from guideline generator 308 and video from camera 304. Guideline generator 308 determines and generates guidelines for use in maneuvering a vehicle based on input from compass 310, vehicle data store 314, and accelerometer 312. In one embodiment, guideline generator 308 determines new guidelines based on a change in direction based on accessing information from compass 310 and/or movement based on accessing information from accelerometer 312. The guidelines generated by generator 308 may be based on vehicle width and length information stored in vehicle data store 314.

Once output by system 300, video stream 320 is displayed on video display 316 where it can be viewed by user's (e.g., driver's) eye 318 and used by the user to help maneuver the vehicle. For example, graphical guidelines displayed on video display 316 may be used to view a rearview image from the vehicle and assist in the driver driving a car in reverse into a parking spot.

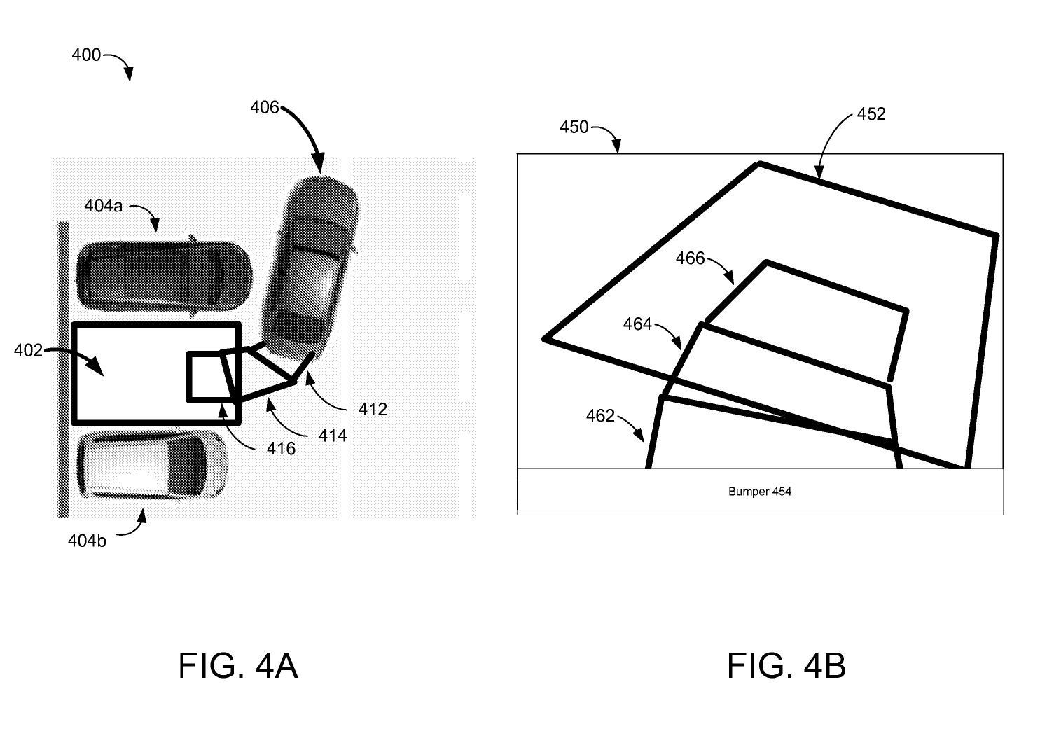

FIGS. 4A-B show exemplary graphical guidelines in accordance with one embodiment of the present invention. FIG. 4A shows exemplary guidelines from an overhead perspective in accordance with one embodiment of the present invention. Diagram 400 includes parking spot 402, parked cars 404a-b, and car 406. Guidelines 412-416 represent guidelines generated by embodiments of the present invention as car 406 is maneuvered into parking spot 402. For example, guideline 412 is generated by a guideline generator (e.g., by system 200) as car 406 begins to approach parking spot 402.

As car 406 moves further toward parking spot 402 and changes direction, guideline 414 may be generated (e.g., by guideline generator 208 upon receiving information from directional sensor 210 and motion sensor 212). As car 406 continues to move into parking spot 402, guidelines 416 are generated. Guidelines 412-416 may be dynamically generated based on changes in direction of car 406 and motion of car 406.

FIG. 4B shows exemplary graphical guidelines from a display screen perspective in accordance with one embodiment of the present invention. Diagram 450 may be displayed on a display screen of a vehicle. For example, diagram 450 may be displayed on a screen of a navigation system, stereo screen display, video mirror (e.g., a mirror comprising a display that can show a rearview perspective), rearview mirror, or other vehicle display. Diagram 450 may be from a video camera (e.g., optical sensor 204) and includes bumper 454 and parking spot 452.

Diagram 450 further includes graphical guidelines 462-464 which are dynamically generated (e.g., by guideline generator 208). Guidelines 462 are automatically generated as a vehicle (e.g., car 406) approaches parking spot 452. As the vehicle moves closer to parking spot 452, guidelines 464 and 466 are generated respectively. Guidelines 462-466 reflect changes in direction of the vehicle as it moves into parking spot 452 and straightens out. The guideline can be used by a driver to assist in the parking maneuver. In one embodiment, guidelines 462, 464, and 466 are generated when the vehicle is shifted into reverse or motion in a reverse direction is detected. In another embodiment, guidelines 462, 464, and 466 are generated when a vehicle is moved toward a parking spot or parking lot based on image recognition.

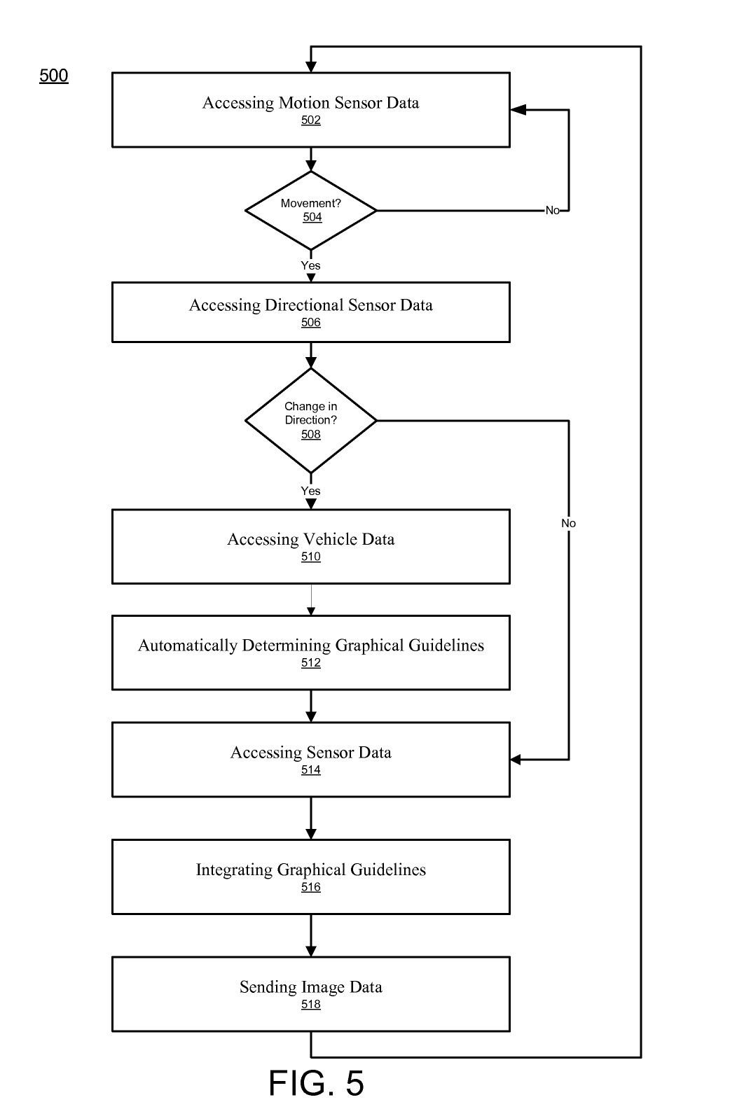

With reference to FIG. 5, flowchart 500 illustrates example functions used by various embodiments of the present invention. Flowchart 500 includes processes that, in various embodiments, are carried out by a processor under the control of computer-readable and computer-executable instructions which may be stored on a computer-readable medium. Although specific function blocks (“blocks”) are disclosed in flowchart 500, such steps are examples. That is, embodiments are well suited to performing various other blocks or variations of the blocks recited in flowchart 500. It is appreciated that the blocks in flowchart 500 may be performed in an order different than presented, and that not all of the blocks in flowchart 500 may be performed.

FIG. 5 shows a flowchart of an exemplary computer implemented process for outputting video in accordance with one embodiment of the present invention. Portions of process 500 may be carried out in preparing a video stream (e.g., video stream 320) for sending to a display screen for use in maneuvering a vehicle (e.g., vehicle 100).

At block 502, motion sensor data is accessed. As described herein, motion sensor data may be accessed from an accelerator.

At block 504, whether there was movement of an object (e.g., vehicle) is determined. If it is determined that there was movement, block 506 is performed. If it is determined that there was no motion block 502 is performed.

At block 506, directional sensor data is accessed. In one embodiment, directional sensor data is accessed from a compass or global positioning system (GPS) device.

At block 508, whether a change in direction is determined based on the directional sensor data. As described herein, a change in direction may be determined based on a change in the direction sensor data from a compass. If there was change in direction, block 510 is performed. If there was no change in direction block 514 is performed.

At block 510, vehicle data is accessed. As described herein, the vehicle information is operable for the generating guidelines. For example, the vehicle data may include the length and width of the vehicle.

At block 512, the graphical guidelines are automatically determined. As described herein, guidelines can be determined based on the length and width of the vehicle. In one embodiment, guidelines are generated dynamically as each direction change is determined.

At block 514, sensor data is accessed. As described herein the sensor data may be accessed from an optical sensor (e.g., video camera, infrared imaging camera, etc.).

At block 516, graphical depictions of the guidelines in video form are integrated into the sensor data. As described herein, guidelines may be multiplexed or integrated into the data from an optical sensor.

At block 518, image data is sent. As described herein, the image data may comprise images and guidelines and output over a video output interface.

FIG. 6 shows exemplary components of a system with computing functionality for providing a rear view image in accordance with one embodiment of the present invention. In its most basic configuration, system 600 typically includes at least one processing unit 602 and computer readable storage medium 618. Depending on the exact configuration and type of computing system environment, computer readable storage medium 618 may be volatile (such as RAM), non-volatile (such as ROM, flash memory, etc.) or some combination of the two. Portions of computer readable storage medium 618 when executed facilitate output of video comprising guidelines (e.g., process 500). System 600 includes directional sensor 610, motion sensor 612, optical sensor 604, power connection 616, image connection 614, and processing unit 602.

Additionally, computing system environment 600 may also have additional features/functionality. For example, computing system environment 600 may also include additional storage (removable and/or non-removable) including, but not limited to, magnetic or optical disks or tape. Such additional storage is illustrated in FIG. 6 by removable storage 608 and non-removable storage 610. Computer storage media includes volatile and nonvolatile, removable and non-removable media implemented in any method or technology for storage of information such as computer readable instructions, data structures, program modules or other data. Computer readable medium 618, removable storage 606 and nonremovable storage 608 are all examples of computer storage media. Computer storage media includes, but is not limited to, RAM, ROM, EEPROM, flash memory or other memory technology, or any other medium which can be used to store the desired information and which can be accessed by system 600. Any such computer storage media may be part of computing system environment 600.

In one embodiment, computer readable storage medium 618 includes guideline generator and integration module 620. Guideline generator and integration module 620 includes directional sensor data access module 622, direction change determination module 624, guideline determination module 626, sensor data access module 628, data store access module 630, and image output module 632. Guideline generator and integration module 620 further includes motion sensor data access module 634, guideline integration module 636, motion determination module 638, image flattening module 640, and data store 642.

Directional sensor data access module 622 is operable to access directional sensor data from direction sensor 610. Direction change determination module 624 is operable to determine a change in direction (e.g., of a vehicle) based on data accessed via directional sensor data access module 622. Guideline determination module 626 is operable to determine guidelines based on data from data store 642 (e.g., length and width of a vehicle) and directional data sensor data access module 622. Sensor data access module 628 is operable to access data from a sensor (e.g., optical sensor 204). Data store access module 630 is operable access data from data store 630 (e.g., vehicle dimensions). Image output module 632 is operable to output image or video over image connection 614 (e.g., coupled to a display screen).

Motion sensor data access module 634 is operable to access motion sensor data from motion sensor 612. Motion determination module 638 is operable to determination whether movement (e.g., of a vehicle) has occurred. Guideline integration module 636 is operable to integrate guidelines from guideline determination module 626 with data from optical sensor 604. Image flattening module 640 is operable to flatten and image received from optical sensor 604 where optical sensor 604 includes a wide angle lens. Data store 642 is operable to store a variety of information including vehicle dimensions.

In this fashion, embodiments of the present invention facilitate display of external perspectives of a vehicle with dynamic guidelines while not requiring control signal connections or custom wire harnesses. Embodiments of the present invention are thereby operable to provide vehicle system independent (e.g., navigation system and video mirror independent) rearview video perspectives. Embodiments of the present invention further provide for dynamic guidelines without the latency of conventional systems.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A system comprising:
an optical sensor;
a directional sensor;
an electronic guideline generator for generating graphical guidelines based on at least one dimension of an object coupled to said optical sensor; and
a video interface for outputting data comprising information received from said optical sensor and said electronic guideline generator, wherein said video interface is operable to output said data to a navigation system.

2. The system of claim 1 further comprising:
a motion sensor coupled to said electronic guideline generator, wherein said directional sensor and said motion sensor are independent of any control signals of any vehicle navigation system.

3. The system of claim 1 wherein said motion sensor is an accelerometer.

4. The system of claim 3 wherein said optical sensor is a video camera.

5. The system of claim 1 wherein said optical sensor is operable for infrared imaging.

6. The system of claim 1 wherein said at least one dimension of an object is a width of a vehicle.

7. The system of claim 1 wherein said at least one dimension of an object is a length of a vehicle.

8. The system of claim 1 wherein said directional sensor is a compass and where said video interface comprises a video multiplexer.

9. The system of claim 1 wherein said motion sensor is a gyroscope.

10. A system for generating a video signal for display on a display screen, said system comprising:
a camera;
a compass;
an accelerometer;
an electronic guideline generator operable to generate images of a plurality of graphical guidelines, said electronic guideline generator coupled to said compass and to said accelerometer; and
a video output interface operable to be coupled to a display device of a video mirror.

11. A system as described in claim 10 further comprising:
a multiplexer operable to multiplex signals from said electronic guideline generator and said camera, wherein said compass and said accelerometer are independent of any control from any vehicle video mirror.

12. A system as described in claim 11 wherein said camera is a wide angle lens camera and further comprises a processing unit operable to flatten an image captured by said camera.

13. A system as described in claim 11 wherein said camera is an infrared imaging camera.

14. A system as described in claim 11 wherein said electronic guideline generator is operable to generate said images of said plurality of guidelines based on a length and width of a vehicle.

15. A method for automatically generating graphical guidelines for aiding in vehicle maneuvering, said method comprising:
accessing, within an electronic system, directional sensor data;
automatically determining a plurality of graphical guidelines based on said directional sensor data;
accessing sensor data;
integrating said plurality of graphical guidelines into data from said sensor; and
sending image data comprising said plurality of guidelines and said data from said sensor to a display unit for display thereof, wherein said directional sensor data is collected by a directional sensor that is independent of any control from any vehicle navigation system.

16. The method of claim 15 wherein said sensor is an optical sensor.

17. The method of claim 16 further comprising:
accessing motion sensor data.

18. The method of claim 16 wherein said directional sensor data is from a compass.

19. The method of claim 16 further comprising:
determining a change in direction based on said directional sensor data.

20. The method of claim 16 wherein said plurality of graphical guidelines is determined based on a length and a width of an object.
